(19) United States
(12) Patent Application Publication
(10) Pub. No.: US 2025/0039838 A1
(43) Pub. Date: Jan. 30, 2025

(54) INTEGRATED SENSING AND COMMUNICATION (ISAC) CONFIGURATION DESIGN

(71) Applicant: ZTE CORPORATION, Shenzhen (CN)

(72) Inventors: Juan LIU, Shenzhen (CN); Chuangxin JIANG, Shenzhen (CN); Zhiqiang HAN, Shenzhen (CN)

(21) Appl. No.: 18/716,322

(22) PCT Filed: Nov. 18, 2022
(86) PCT No.: PCT/CN2022/132884

§ 371 Date: Jun. 4, 2024

(51) Int. Cl. H04W 64/00; H04W 16/28; H04W 24/02

(52) U.S. Cl. CPC H04W 64/006; H04W 16/28; H04W 24/02

(57) ABSTRACT

Provided are methods, apparatus, and systems that relate to configuration scheme design in ISAC systems. In one example aspect, a method for wireless communication includes communicating, by a first wireless communication device to a second wireless communication device, a signal including a configuration information, and performing, by the second wireless communication device, an operation that combines a sensing functionality and a communication functionality using the configuration information for at least one use case(s).

### TECHNICAL FIELD

This patent document is related to wireless communication and sensing.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

### SUMMARY

This patent document discloses techniques, among other things, related to ISAC configuration scheme design.

In one example aspect, wireless communication method is disclosed. The method includes communicating, by a first wireless communication device to a second wireless communication device, a signal including a configuration information, and performing, by the second wireless communication device, an operation that combines a sensing functionality and a communication functionality using the configuration information for at least one use case(s).

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

### BRIEF DESCRIPTION OF THE DRAWING

FIGS. 1-2 show flow charts of examples of communicating configuration information between SF or LMF and a wireless communication device.

FIGS. 3-4 show flow charts of examples of communicating configuration information between gNB and a wireless communication device.

FIGS. 5-8 show diagrams of examples of reporting structures for positioning and sensing.

FIG. 9 shows a diagram of an example of mapping relationship between use cases and the resource(s).

FIG. 10 shows a diagram of an example of transmitting pre-configured reference signal configuration between two wireless communication devices.

FIG. 11 shows a diagram of an example of transmitting signaling of one or more wireless communication device(s) between two wireless communication devices.

FIG. 12 shows a diagram of an example of transmitting data of one or more wireless communication device(s) between two wireless communication devices.

FIG. 13 shows a diagram of an example of transmitting other information between two wireless communication devices.

FIG. 14 shows a diagram of an example of information transaction among different wireless communication devices.

FIG. 15 shows a diagram of an example of transmitting one or more threshold(s) for sensing between two wireless communication devices.

FIG. 16 shows a flowchart of an example of information transaction.

FIG. 17 shows an exemplary block diagram of a hardware platform that may be a part of a network device or a communication device.

FIG. 18 shows an example of network communication including a base station (BS) and user equipment (UE) based on some implementations of the disclosed technology.

FIGS. 19-24 are flowcharts representation of methods for wireless communication in accordance with one or more embodiments of the present technology.

### DETAILED DESCRIPTION

Headings for the various sections below are used to facilitate the understanding of the disclosed subject matter and do not limit the scope of the claimed subject matter in any way. Accordingly, one or more features of one section can be combined with one or more features of another section. Furthermore, 5G or ISAC terminology is used for the sake of clarity of explanation, but the techniques disclosed in the present document are not limited to 5G or ISAC technology only and may be used in wireless systems that implemented other protocols.

With the emergence and development of the fifth generation (5G) wireless communication technology, the integrated sensing and communication (ISAC) system, which aims to implement both sensing and communication functionalities on the same hardware platform, has become a new research hotspot. The ISAC has shown a great superiority in alleviating frequency band congestion and reducing hardware cost, and has been regarded as one of the key technologies in autonomous vehicular networks, perceptive mobile networks, and so on.

Recently, ISAC has been a popular research topic in academic area. ISAC also attracts interests from the industry area including standard institution. However, none of the existing study in ISAC covers the configuration scheme, which can be essential for scandalizing a technique. Moreover, none of the existing research touches the topic of how to combine the ISAC configuration with the existing configuration scheme for positioning, which is a critical issue to face when embracing the ISAC with the existing communication systems.

This document discloses, among other things, method, apparatus and devices involving configuration for ISAC, e.g., the configuration scheme, parameters required in the configuration and the controlling signaling design in ISAC.

The proposed methods and schemes in the current application are beneficial in at least three aspects: 1) propose configuration scheme for ISAC, which is essential to the future industrialization and/or standardization process, 2) propose measurement reporting adopting a re-use scheme for sensing and positioning, which saves communication resource such as signaling resource, and 3) propose a variety of methods for a sensing scheme with a device dependent threshold, which helps to improve the accuracy and efficiency in a ISAC system.

The details of the proposed methods will be discussed in the following embodiments.

### Embodiment 1

This section discloses, among other things, examples of configuration scheme design that can be used in ISAC system.

The disclosed configuration design can be communicated from one wireless communication device to another wireless communication device.

For example, a wireless communication device may configure or indicate a configuration information related to one or more use cases to another wireless communication device.

The configuration information may include at least one of: a sensing mode, a signal, a signal set, a sensing method, a TRP, a resource, a resource set, a parameter, beam information, direction information, a list of wireless communication devices.

Here, the wireless communication device can be at least one of: a user equipment (UE), a network node, a base station, a transmission/reception point (TRP), a local sever, a Sensing Function (SF) or a Location Management Function (LMF).

In one aspect, the configuration information can be used in one or more use cases. For example, a use case can be related to communication, positioning or sensing.

The configuration or the indication may be used for one or more use cases.

In one example, a resource or a resource set contained in the configuration information may be configured for sensing and/or communication.

In another example, a resource or resource set contained in the configuration may be configured for measurement of sensing and/or communication.

In one aspect, the parameter in the configuration information may be related to time domain of the signal, frequency domain of the signal, coding domain of the signal or spatial domain of the signal, the resource or resource set.

In another aspect, the beam information or direction information in the configuration information may be configured for sensing.

In one example, the beam information or direction information in the configuration information may be configured per resource or per resource set.

In another example, the resource in the configuration information is configured for sensing is per resource or per resource set.

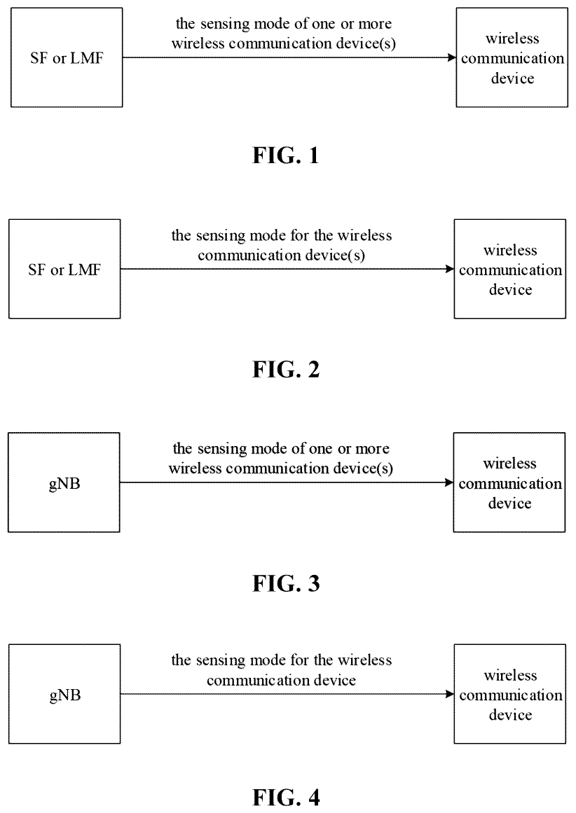

In another example, the parameter may be related to sensing mode, as shown in FIGS. 1-4.

The sensing mode can be designed to include multiple schemes.

For example, the sensing mode may relate to at least one of the following modes: 1) sensing by the wireless device itself, 2) sensing by other wireless communication device(s) or 3) joined sensed by the wireless device itself and other wireless communication device(s).

In another example, the sensing mode may relate to at least one of: 1) the sensing/receiving and the transmitting wireless operations are all conducted by a single wireless communication device, which may indicated by ‘1’ or ‘0’, or 2) the above operations are conducted by two or more wireless communication devices with one wireless communication device for transmitting and the other wireless communication device for sensing/receiving, which may indicated by ‘0’ or ‘1’.

There can be an indication in the configuration scheme showing whether the sensing/receiving and the transmitting are conducted by a single device or more than one device. For example, in a first case, an indication can show that a single device is used for the sensing/receiving and the transmitting. In a second case, an indication can show that two or more wireless communication devices participate in the transmitting, sensing/receiving process. In particular, a first wireless communication device is in charge of the transmitting and a second wireless communication device is in charge of the sensing/receiving.

In the above examples, the indication may be configured by a user equipment (UE), a network node, a base station, a transmission/reception point (TRP), a local sever, a Sensing Function (SF) or a Location Management Function (LMF).

The proposed configuration schemes can be from a gNB to a gNB, or in from a UE to a UE.

In one example, a wireless communication device has a sensing capability may/can be configured with sensing function.

In one example, the signal in the configuration information may comprise at least one of: downlink positioning reference signal (DL-PRS) or uplink positioning reference signal (UL-SRS).

In one example, the resource/or the resource set for sensing and communication may be different. In other words, the resource/resource set adopted for sensing and that for communication are independent of each other.

In another example, the resource or resource set for sensing can be indicated by a wireless communication device.

In one example, the parameter in the configuration information is configured to represent different indication.

For example, in one implementation, the parameter having value 0 represents that the resource or resource set is used for sensing. The parameter having value 1 represents the resource or resource set is used for communication or positioning.

In one implementation, the parameter having value 1 represents that the resource or resource set is used for sensing. The parameter having value 0 represents the resource or resource set is used for communication or positioning.

In one implementation, the presence of the parameter in the configuration information indicates sensing is supported.

In one implementation, the presence of the parameter in the configuration information indicates sensing is not supported.

In one implementation, the parameter may have values selected from a pre-defined enumeration list. In a particular example, the parameter is one or more enumeration value(s), at least one of: 1) one or more enumeration value(s) indicating sensing, or 2) one or more enumeration value(s) indicating positioning or communication. In a particular example, the parameter of value “sense” represents sensing. In another particular example, the parameter of value “pos” represents positioning.

### Embodiment 2

This section discloses, among other things, examples involving combining the measurement or reporting structure for sensing with the measurement or reporting structure for positioning. The existing systems only cover the measurement or reporting structures for positioning. There is a need to design an applicable scheme for sensing used in ISAC system conforming with the existing scheme for positioning.

In a first case, measurement reporting for sensing, communication or positioning are independent of each other. This is shown as an example in FIG. 5.

Here, the independency may refer to a measurement report time or a measurement report structure. In other words, the measurement report time or the measurement structure for sensing, communication or positioning are not related to each other.

For example, according to an existing scheme in the standard

This information element contains the response time of the measurement results reporting.

| | | | | |
|---|---|---|---|---|
| | | | IE Type and | |
| IE/Group Name | Presence | Range | Reference | Semantics Description |

| | | |
|---|---|---|
| Time | M | INTEGER(1 . . . 128, . . . ) |
| Time Unit | M | ENUMERATED |
| | | (second, ten- |
| | | seconds, ten- |
| | | milliseconds, . . . ) |

Above is the response time for positioning. In sensing, the response time is not exist or the response time for sensing is not related to the response time for positioning.

In another example, the measurement reporting structure for sensing is not necessary the same structure as positioning or communication measurement report structure.

For example, in a first case, some information included in one measurement report structure (e.g., the positioning measurement report structure) is not included in the other measurement report structure (e.g., the sensing measurement report structure). In a particular example, the CSI or SSB related measurement results may be included in the positioning structure but not included in the sensing structure.

On the other hand, measurement reporting for sensing, communication or positioning can be dependent.

Here, the dependency may refer to a measurement report time or measurement report structure. In other words, the measurement report time or measurement report structure of sensing, communication or positioning can be related to each other.

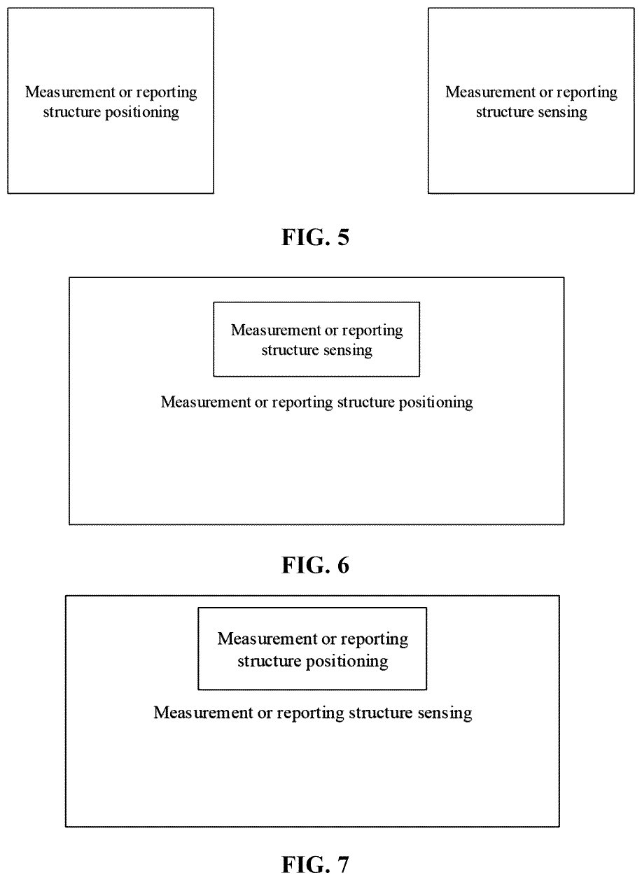

In one example, the measurement or reporting structure for sensing is part of positioning or communication measurement report structure. This is shown as an example in FIG. 6.

In a particular example, the measurement or reporting structure for positioning may include information A, B, C and D; the measurement or reporting structure for sensing may include information A. In this case, the measurement or reporting structure for sensing is included in the measurement or reporting structure for positioning. In other words, a wireless communication device can transmit only the measurement or reporting structure positioning once, i.e., A, B, C and D, without retransmitting A for sensing. When receiving this measurement or reporting structure, another wireless communication device can reuse part of the information, i.e., A, in the transmission for sensing. This re-use scheme improves the efficiency of communication and saves communication resource such as the signaling resource.

In another example, the measurement or reporting structure for positioning or communication is part of sensing measurement report structure. This is shown as an example in FIG. 7.

In a particular example, the measurement or reporting structure for sensing may include information A, B, C and D; the measurement or reporting structure for positioning may include information A. In this case, the measurement or reporting structure for positioning is included in the measurement or reporting structure for sensing. In other words, a wireless communication device can transmit only the measurement or reporting structure sensing once, i.e., A, B, C and D, without retransmitting A for positioning. When receiving this measurement or reporting structure, another wireless communication device can reuse part of the information, i.e., A, in the transmission for positioning. Similarly, as the above example, this re-use scheme improves the efficiency of communication and saves communication resource such as the signaling resource.

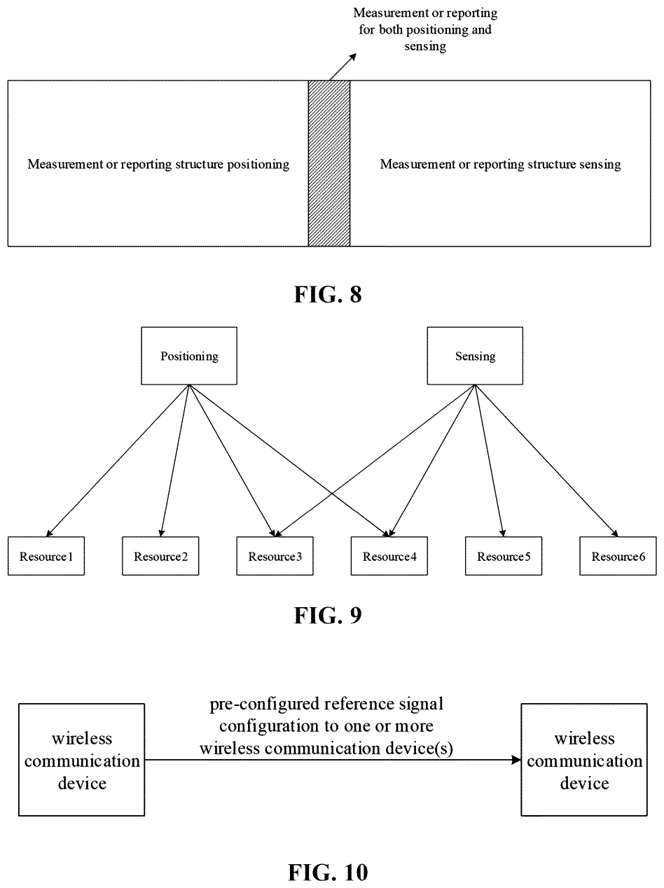

In yet another example, a part of measurement or reporting structure for sensing and positioning or communication is overlapped. This is shown as an example in FIG. 8.

In a particular example, the measurement or reporting structure for sensing may include information A, B, C and D; the measurement or reporting structure for positioning may include information C, D, E and F. In this case, the measurement or reporting structure for positioning and the measurement or reporting structure for sensing have overlap, i.e., C and D. In other words, a wireless communication device can transmit the measurement or reporting structure including A, B, C, D, E and F, without retransmitting C and D twice. When receiving this measurement or reporting structure, another wireless communication device can reuse part of the information, i.e., C and D, in the transmission for positioning and sensing. Similarly, as the above examples, this re-use scheme improves the efficiency of communication and saves communication resource such as the signaling resource.

In yet another example, some of the parameters can be reused for positioning and sensing. For example, the parameters may include at least one of the following: time stamp, measurement parameter granularity, measurement parameter unit, Measurement Quality, beam information, or measurement parameter Line-of-Sight (Los) or Non-Line-of-Sight (NLos) indicator.

### Embodiment 3

This embodiment discloses, among other things, multiple examples involving determining sensing information in ISAC system.

In particular, examples involving determine Time difference of Arrival (TDOA) reference nodes for sensing and positioning are discloses.

TDOA reference nodes are required for synchronizing different base stations to determine a position information of a wireless communication device in 5G.

No existing study or research relates to designing a scheme to determine TDOA reference nodes for sensing used in ISAC combined with the TDOA determination for a traditional positioning use case.

In a first proposed solution, the reference wireless communication device for sensing can be different from that for the positioning. In particular, the reference wireless communication device for sensing is determined by a first method; the reference wireless communication device for positioning is determined by a second method. The first method is not necessary to be the same as the second method. Therefore, the determined reference device(s) under both scenarios are not necessary to be the same.

Alternatively, the reference wireless communication device for sensing and that for positioning are independently configured for a wireless communication device.

In another example, the resource or resource set for reference wireless communication device for sensing and that for positioning are different for the same wireless communication device.

In yet another example, the resource or resource set for reference wireless communication device for sensing and that for positioning are independently configured for the same wireless communication device.

In another example, resource ID(s) under the same resource set is configured. In a particular example, one resource set may include one or more resource(s), the resource ID used to identify different resource. In a particular example, one resource is related to one resource ID.

In one example, a round trip time (RTT) for sensing may indicate the absolute time from the transmitting wireless communication device to the receiving/sensing wireless communication device.

In another example, a Tx-Rx time difference for sensing may indicate the relative/absolute time from the transmitting wireless communication device to the receiving/sensing wireless communication device.

In another example, a Rx-Tx time difference for sensing may indicate the relative/absolute time from the receiving/sensing wireless communication device to the transmitting wireless communication device.

To determine TDOA reference node for sensing, other measurement parameter can be required.

For example, sometimes, a parameter indicating a relative timing difference for sensing is required. This relative timing difference may use a group of assistant wireless communication device(s) to help with receiving or sensing.

In another example, a parameter indicating an absolute timing difference for sensing is required. This absolute timing difference may use a group of assistant wireless communication devices to help with receiving or sensing.

### Embodiment 4

This embodiment discloses, among other things, multiple examples involving how to configuration information maps to at least one use case.

This embodiment is related to Embodiment 1.

In one example, the information included in the configuration information can related to one or more use cases. In particular, the information may include at least one of: beam information, resource, resource set, or direction information.

The use cases can be at least one of: communication, positioning, or sensing.

In one example, there are at least two use cases involving positioning and sensing. This is shown as an example in FIG. 9.

As shown in FIG. 9, there are two use cases: positioning and sensing. There are also 6 resources available, i.e., Resource 1-6. Here, the use case of positioning may use Resources 1-4 and the use case of sensing may use Resources 3-6. In this particular example, the positioning and sensing use cases share certain resources, e.g., Resource 3 and Resource 4. In other words, Resource 3 and Resource 4 can be used by both use cases.

In another example, the information for sensing and the information for positioning are configured independently.

In yet another example, the information for sensing is part of the information for positioning. In other words, the information for positioning includes that for sensing. Therefore, part of the information can be reused by sensing and positioning use cases.

In yet another example, the information for positioning is part of the information for sensing. In other words, the information for sensing includes that for positioning. Therefore, part of the information can be reused by sensing and positioning use cases.

### Embodiment 5

This embodiment discloses among other things, examples involving signaling procedure of sensing in ISAC.

A wireless communication device can send signal containing configuration information to another wireless communication device.

Here, the wireless communication device can be at least one of: a user equipment (UE), a network node, a base station, a TRP, a local sever, a SF or a LMF.

FIG. 10 discloses an example of a wireless communication device sends a pre-configured reference signal configuration of one or more other wireless communication devices.

In a particular example, according to FIG. 10, the wireless communication device in the left rectangle may refer to a SF or a LMF, The wireless communication device in the right rectangle and the wireless communication device in the middle may refer to TRP or gNB.

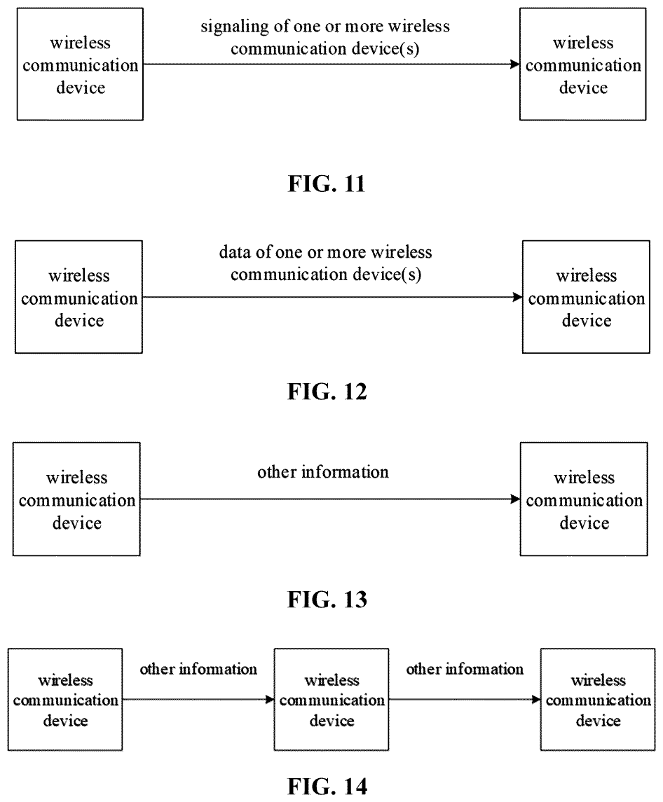

In another example, the signaling of one or more wireless communication devices is transmitted between two wireless communication devices. This is shown in FIG. 11.

In another example, the data of one or more wireless communication device is transmitted between two wireless communication devices. This is shown in FIG. 12.

In particular, the communication of signaling (FIG. 10) may occur before or after the communication of data (FIG. 11).

In another example, the data in FIG. 12 is a prior. In particular, the communication of data (FIG. 12) may occur before or after the communication of other (FIG. 13).

In yet another example, as disclosed in FIG. 13, a wireless communication device can communicate other information to another wireless communication device.

Here, the other information may comprise at least one of: beam information, bandwidth information, time stamp, period of sensing information, sequence type, sequence information, sequence length, bit stream, the modulation type, power related information, slot index, symbol index, time information of signal information or frequency domain information of signal information.

In a particular example, the sequence information may comprise at least one of: synchronization signal block (SSB), a physical uplink shared channel (PUSCH), a physical uplink control channel (PUCCH), a physical downlink shared channel (PDSCH), a physical downlink control channel (PDCCH), a DeModulation Reference Signal (DMRS), a physical random access channel (PRACH), a positioning reference signal (PRS), a sounding reference signal (SRS), a channel state information (CSI), self-defined sequence.

In a particular example, the frequency domain of the other information may include one section or more multiple segment signal component or composition.

In a particular example, the time domain of the other information occupy one or more symbol(s) or specific time duration.

In another example, the signal of frequency domain of the other information is at least one of: Uniform PRB-level gap, Non-uniform PRB-level gap, Uniform RE-level gap, Non-uniform RE-level gap, or frequency continuous.

In yet another example, the signal of frequency domain of the other information is at least one of: same PRB-level or RE-level gap, one or more different PRB-level or RE-level gap, frequency continuous.

In a particular example, the transmission manner in the above examples can be at least one of: broadcast, uni-cast, or group cast.

In yet another examples, the wireless communication device in the left and right rectangle of FIGS. 10-13 may refer to a user equipment (UE), a network node, a base station, a transmission/reception point (TRP), a local sever, a Sensing Function (SF) or a Location Management Function (LMF).

### Embodiment 6

This embodiment discloses, among other things, examples involving conducting sensing operation in an ISAC system.

The sensing operation in ISAC may encounter more difficulties than the other communication schemes. For example, the signal strength decreases dramatically in ISAC environment, which made the sending decision more challenging in ISAC than other communication systems. A wireless communication device needs to determine how to sense certain information under ISAC system.

In one proposed example, a wireless communication device can determine a threshold to help with the sensing operation.

In particular, the threshold is device dependent. In other words, different wireless communication device(s) may set different thresholds for sensing operations. This flexibility increases the efficiency of sensing for a wireless communication device under the ISAC system.

In another example, the threshold can further depend on other parameters of a wireless communication device. For example, the threshold can depend on a direction, a beam, a resource, or an angle for a wireless communication device. In other words, a single wireless communication device may set different thresholds on different directions, resource(s), beams, or angles. This may further increase the flexibility and efficiency for a wireless communication device to conduct sensing operation under the ISAC system.

In yet another examples, the threshold(s) of sensing can be configured by other wireless communication devices. In a particular example, a wireless communication device, a LMF or a SF may configure at least one threshold(s) for the wireless communication device with sensing capacity. After receiving the pre-configured threshold(s), the wireless communication device may conduct sensing operation based on the threshold(s).

A wireless communication device may also need to determine a way to set the threshold for sensing. Several proposed methods are discussed below.

In one implementation, at least two parameters are configured for a wireless communication device for conducting sensing operation. In particular, one parameter can be a time stamp indicating the time instance at which the RSRP/RSRPP (if included) measurement is performed or reporting. Another parameter can relate to a signal strength. For example, reference signal received power (RSRP) or reference signal received path power (RSPRP) can be used as a second parameter to help a wireless communication device to determine the threshold. Here, the parameter of RSRP or RSRPP can be either at a time instance or within a time duration.

In one implementation, at least one parameter is configured for a wireless communication device for conducting the sensing operation. In a specific example, the parameter may relate to a signal strength. For example, reference signal received power (RSRP) or reference signal received path power (RSPRP) can be adopted to help the wireless communication device to determine a threshold. Here, the parameter of RSRP or RSRPP can be either at a time instance or within a time duration.

In one implementation, a difference or a change of a parameter can be adopted to help a wireless communication device to conduct sensing operations. For example, a difference or a change of RSRP/reference signal received path power (RSPRP) can be configured for a wireless communication device with sensing capability. In one example, the change or the different of RSRP/RSRPP can be the differences of RSRP/RSRPP values at different time instance or in different time durations.

In one implementation, an absolute or a relative threshold(s) are configured for a wireless communication device for sensing operations.

FIG. 16 shows an example flowchart representation of a method for wireless communication in accordance with one or more embodiments of the present technology. Operation 1602 includes setting the absolute or relative threshold(s) for a wireless communication device or a direction/beam/angle/resource per wireless communication device. Operation 1604 is optional for this operation flow. Operation 1604 configures the threshold(s) scheme. After the operation 1602 or 1604, operation 1606 can be performed to use the threshold (s), configured in operation 1602, for sensing.

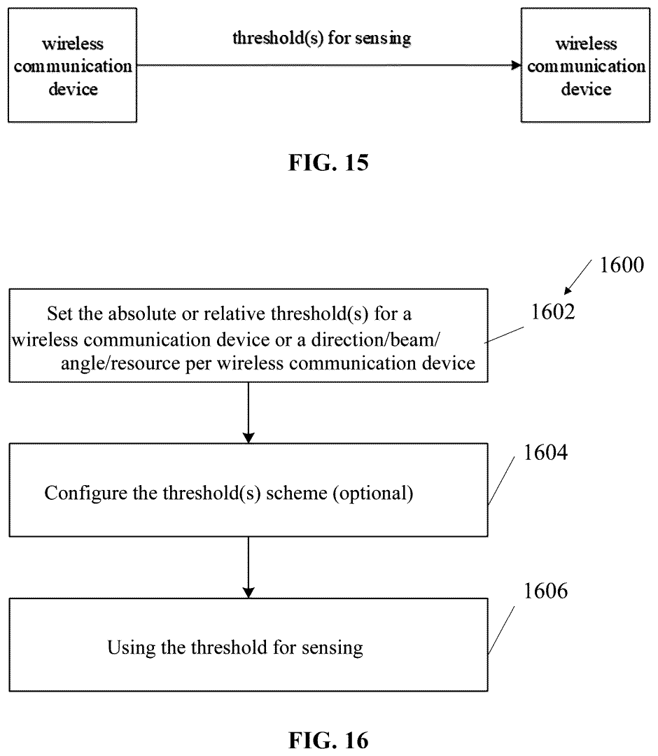

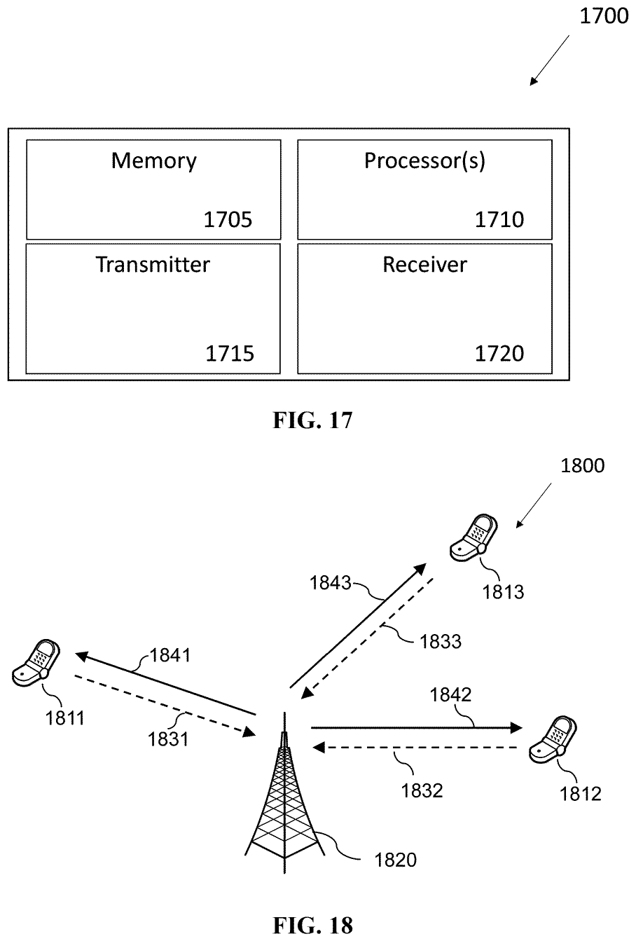

FIG. 17 shows an exemplary block diagram of a hardware platform 1700 that may be a part of a network device (e.g., base station) or a communication device (e.g., a user equipment (UE)). The hardware platform 1700 includes at least one processor 1710 and a memory 1705 having instructions stored thereupon. The instructions upon execution by the processor 1710 configure the hardware platform 1700 to perform the operations described in FIGS. 1 to 16 and in the various embodiments described in this patent document. The transmitter 1715 transmits or sends information or data to another device. For example, a network device transmitter can send a message to user equipment. The receiver 1720 receives information or data transmitted or sent by another device. For example, user equipment can receive a message from a network device.

The implementations as discussed above will apply to a network communication. FIG. 18 shows an example of a communication system (e.g., a 5G or NR cellular network) that includes a base station 1820 and one or more user equipment (UE) 1811, 1812 and 1813. In some embodiments, the UEs access the BS (e.g., the network) using a communication link to the network (sometimes called uplink direction, as depicted by dashed arrows 1831, 1832, 1833), which then enables subsequent communication (e.g., shown in the direction from the network to the UEs, sometimes called downlink direction, shown by arrows 1841, 1842, 1843) from the BS to the UEs. In some embodiments, the BS send information to the UEs (sometimes called downlink direction, as depicted by arrows 1841, 1842, 1843), which then enables subsequent communication (e.g., shown in the direction from the UEs to the BS, sometimes called uplink direction, shown by dashed arrows 1831, 1832, 1833) from the UEs to the BS. The UE may be, for example, a smartphone, a tablet, a mobile computer, a machine to machine (M2M) device, an Internet of Things (IoT) device, and so on.

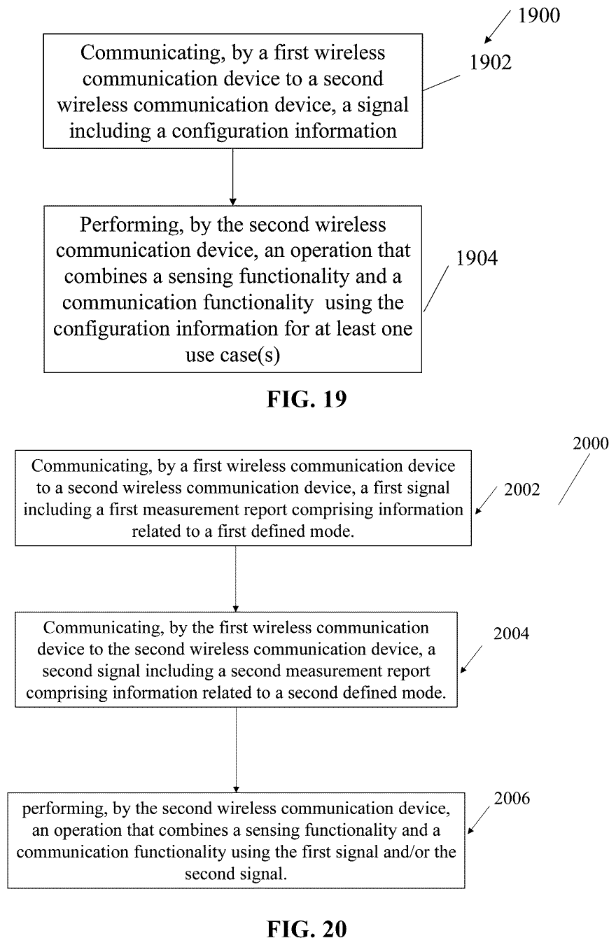

FIG. 19 shows an example flowchart representation of a method for wireless communication in accordance with one or more embodiments of the present technology. Operation 1902 includes communicating, by a first wireless communication device to a second wireless communication device, a signal including a configuration information. Operation 1904 includes performing, by the second wireless communication device, an operation that combines a sensing functionality and a communication functionality using the configuration information for at least one use case(s).

FIG. 20 show an example flowchart representation of a method for wireless communication in accordance with one or more embodiments of the present technology. Operation 2002 includes communicating, by a first wireless communication device to a second wireless communication device, a first signal including a first measurement report comprising information related to a first defined mode. Operation 2004 includes communicating, by the first wireless communication device to the second wireless communication device, a second signal including a second measurement report comprising information related to a second defined mode. Operation 2006 includes performing, by the second wireless communication device, an operation that combines a sensing functionality and a communication functionality using the first signal and/or the second signal.

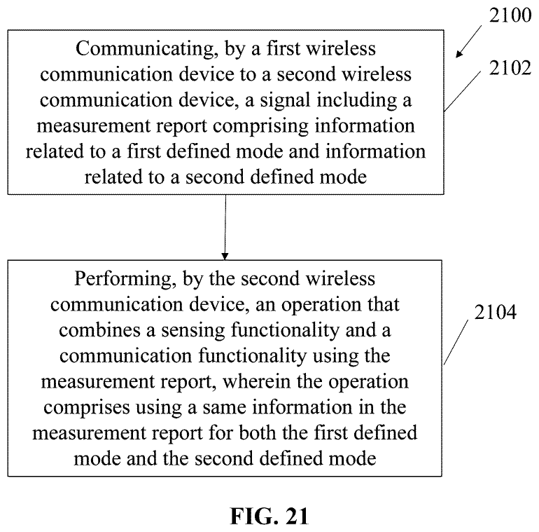

FIG. 21 show an example flowchart representation of a method for wireless communication in accordance with one or more embodiments of the present technology. Operation 2102 includes communicating, by a first wireless communication device to a second wireless communication device, a signal including a measurement report comprising information related to a first defined mode and information related to a second defined mode. Operation 2104 includes performing, by the second wireless communication device, an operation that combines a sensing functionality and a communication functionality using the measurement report, wherein the operation comprises using a same information in the measurement report for both the first defined mode and the second defined mode.

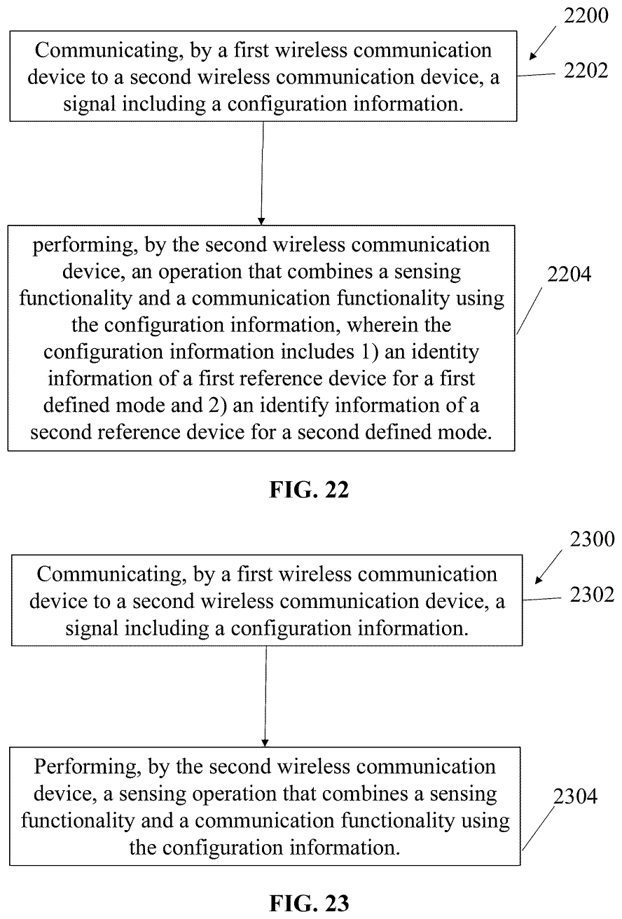

FIG. 22 show an example flowchart representation of a method for wireless communication in accordance with one or more embodiments of the present technology. Operation 2202 includes communicating, by a first wireless communication device to a second wireless communication device, a signal including a configuration information. Operation 2204 includes performing, by the second wireless communication device, an operation that combines a sensing functionality and a communication functionality using the configuration information, wherein the configuration information includes 1) an identity information of a first reference device for a first defined mode and 2) an identify information of a second reference device for a second defined mode.

FIG. 23 show an example flowchart representation of a method for wireless communication in accordance with one or more embodiments of the present technology. Operation 2302 includes communicating, by a first wireless communication device to a second wireless communication device, a signal including a configuration information. Operation 2304 includes performing, by the second wireless communication device, a sensing operation that combines a sensing functionality and a communication functionality using the configuration information.

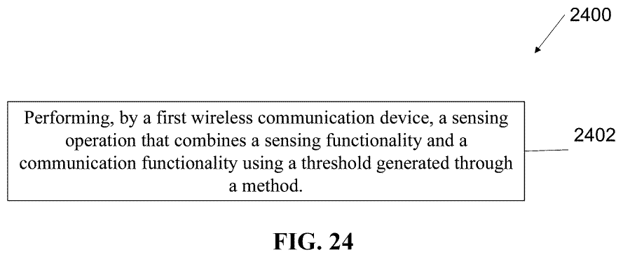

FIG. 24 show an example flowchart representation of a method for wireless communication in accordance with one or more embodiments of the present technology. Operation 2402 includes performing, by a first wireless communication device, a sensing operation that combines a sensing functionality and a communication functionality using a threshold generated through a method.

Various preferred embodiments and additional features of the above-described method of FIGS. 19-24 are as follows. Further examples are described with reference to embodiments 1 to 6.

In one example aspect, a wireless communication method is disclosed. The method includes.

In another example aspect, another wireless communication method is disclosed. The method includes communicating, by a first wireless communication device to a second wireless communication device, a signal including a configuration information, and performing, by the second wireless communication device, an operation that combines a sensing functionality and a communication functionality using the configuration information for at least one use case(s).

In some embodiments, the communicating comprises using at least one of a send, a receive, a broadcast, a unicast, a request, a response, a forward, an exchange or a groupcast.

In some embodiments, the wireless communication device support at least of one: sensing, communicating, positioning.

In some embodiments, the configuration information comprises at least one of: 1) a signal, 2) a signal set, 3) a sensing method, 4) a transmission/reception point (TRP), 5) a resource, 6) a resource set, 7) a parameter, 8) a beam information, 9) a direction information, or 10) a list of wireless communication devices.

In some embodiments, the at least one use case(s) comprises at least of: 1) communication, 2) positioning, or 3) sensing.

In some embodiments, the resource or the resource set is configured for 1) sensing and/or communication, or 2) measurement of sensing and/or communication.

In some embodiments, the parameter is related to at least one of 1) time domain of the signal, 2) frequency domain of the signal, 3) coding domain of the signal, 4) spatial domain of the signal, 5) the resource, 6) the resource set, or 7) a sensing mode.

In some embodiments, the beam information or direction information is configured for sensing.

In some embodiments, the beam information, the direction information or the resource is configured per resource or per resource set.

In some embodiments, the sensing mode is related to at least one of: 1) sensing by the first or second wireless communication device, 2) sensing by at least one other wireless communication devices, or 3) jointly sensed by the first or second wireless communication device and the at least one other device(s).

In some embodiments, the sensing mode is related to at least one of: 1) the first or second wireless communication device conducting sensing, receiving or transmitting operations, 2) the first or second wireless communication device conducting the transmitting operation and at least one other wireless communication device(s) conducting sensing or receiving operation, 3) the first or second wireless communication device conducting the sensing or receiving operation and the at least one other wireless communication device(s) conducting transmitting operation, or 4) the at least one other wireless communication device(s) conducting the sensing or receiving operation and the other wireless communication device(s) conducting transmitting operation.

In some embodiments, the parameter is 0 indicates the resource or the resource set is used for sensing, wherein the parameter is 1 indicates the resources or the resource set is used for communication or positioning.

In some embodiments, the parameter is 1 indicates the resource or the resource set is used for sensing, wherein the parameter is 0 indicates the resources or the resource set is used for communication or positioning.

In some embodiments, the configuration information comprising the parameter indicates sensing is supported.

In some embodiments, the configuration information comprising the parameter indicates sensing is not supported.

In some embodiments, the parameter is one or more enumeration value(s), at least one of: 1) one or more enumeration value(s) indicating sensing, or 2) one or more enumeration value(s) indicating positioning or communication.

In some embodiments, each use case maps to at least one configuration information.

In some embodiments, more than one use cases map to a same configuration information.

In some embodiments, the sensing mode is indicated by at least one of: 1) one value indicates that the sensing, receiving, or transmitting operation are conducted at a same wireless communication device, or 2) one value indicates that the sensing, receiving, transmitting operation are conducted at different wireless communication devices.

In another example aspect, a method for wireless communication, comprising: communicating, by a first wireless communication device to a second wireless communication device, a first signal including a first measurement report comprising information related to a first defined mode; communicating, by the first wireless communication device to the second wireless communication device, a second signal including a second measurement report comprising information related to a second defined mode; and performing, by the second wireless communication device, an operation that combines a sensing functionality and a communication functionality using the first signal and/or the second signal.

In some embodiments, the information related to the first defined mode is independent from the information related to the second defined mode.

In another example aspect, a method for wireless communication, comprising: communicating, by a first wireless communication device to a second wireless communication device, a signal including a measurement report comprising information related to a first defined mode and information related to a second defined mode; and performing, by the second wireless communication device, an operation that combines a sensing functionality and a communication functionality using the measurement report, wherein the operation comprises using a same information in the measurement report for both the first defined mode and the second defined mode.

In some embodiments the information related to the first defined mode is included in the information related to the second defined mode.

In some embodiments the information related to the second defined mode is included in the information related to the first defined mode.

In some embodiments, the information related to the first defined mode and the information related to the second defined mode have overlap, or part of the information related to the first defined mode is the same as part of the information related to the second defined mode.

In another example aspect, a method for wireless communication, comprising: communicating, by a first wireless communication device to a second wireless communication device, a signal including a configuration information; performing, by the second wireless communication device, an operation that combines a sensing functionality and a communication functionality using the configuration information, wherein the configuration information includes 1) an identity information of a first reference device for a first defined mode and 2) an identify information of a second reference device for a second defined mode.

In some embodiments, the identity for the first reference device is determined through a first method, wherein the identity for the second reference device is determined through a second method.

In some embodiments, the first method is different from the second method.

In some embodiments, the configuration information further includes a measurement for the second defined mode.

In some embodiments, the measurement depends on a plurality of wireless communication devices.

In some embodiments, the measurement is a relative timing difference or an absolute timing difference.

In another example aspect, a method for wireless communication, comprising: communicating, by a first wireless communication device to a second wireless communication device, a signal including a configuration information; and performing, by the second wireless communication device, a sensing operation that combines a sensing functionality and a communication functionality using the configuration information.

In some embodiments, the wireless communication device is at least one of 1) a user equipment (UE), 2) a network node, 3) a base station, 4) a transmission/reception point (TRP), 5) a local server, 6) a sensing function (SF), or 7) a Location Management Function (LMF).

In some embodiments, the configuration information comprises: 1) signaling of one or more wireless communication device(s), 2) data of one or more wireless communication device(s), or 3) other information.

In some embodiments, the other information comprises at least one of: 1) beam information, 2) bandwidth information, 3) time stamp, 4) period of sensing information, 5) sequence type, 6) sequence information, 7) sequence length, 8) bit stream, 9) a modulation type, 10) power related information, 11) slot index, 12) symbol index, 13) time information of signal information, or 14) frequency domain information of signal information.

In another example aspect, a method for wireless communication, comprising performing, by a first wireless communication device, a sensing operation that combines a sensing functionality and a communication functionality using a threshold; calculating or generating the threshold through a method.

In another example aspect, a method for wireless communication, comprising performing, by a first wireless communication device, a sensing operation that combines a sensing functionality and a communication functionality using a threshold; or calculating/generating the threshold through a method.

In some embodiments, the threshold related to the first wireless communication device.

In some embodiments, the threshold relates to a parameter of the first wireless communication device.

In some embodiments, the parameter is at least one of: 1) a direction, 2) a beam, 3) a resource, or 4) an angle.

In some embodiments, the method comprises determining the threshold based on 1) a time stamp and 2) a first parameter of a signal strength at a time instance or during a time duration.

In some embodiments, the method comprises determining the threshold based on a second parameter of a signal strength at a time instance or during a time duration.

In some embodiments, the method comprises determining the threshold based on a change of a third parameter of a signal strength through a time period, wherein the third parameter indicates a signal strength at a time instance or during a time duration.

It will be appreciated that the present document discloses methods and apparatus related to configuration design from different aspects in ISAC systems. Although ISAC attracts attention in academic area, none of the existing study for ISAC, covers the configuration scheme or how to combine an ISAC configuration scheme with the existing positioning configuration scheme, which are essential for scandalizing ISAC. This patent application multiple solutions regarding how a wireless communication can generate and communicate configuration information for ISAC, e.g., the configuration scheme, parameters required in the configuration and the controlling signaling design in ISAC. The proposed methods and schemes will improve the communication efficiency and flexibility in ISAC due to at least less overhead and better spectrum utilization.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method for wireless communication, comprising:
communicating, by a first wireless communication device to a second wireless communication device, a signal including a configuration information; and
performing, by the second wireless communication device, an operation that combines a sensing functionality and a communication functionality using the configuration information for at least one use case(s).

2. The method of claim 1, wherein the wireless communication device is at least one of: a user equipment (UE), a network node, a base station, a transmission/reception point (TRP), a local server, a sensing function (SF), or a Location Management Function (LMF).

3. The method of claim 1, wherein the configuration information comprises at least one of: a signal, a signal set, a sensing method, a transmission/reception point (TRP), a resource, a resource set, a parameter, a beam information, a direction information, or a list of wireless communication devices.

4. The method of claim 1, wherein the at least one use case(s) comprises at least of: communication, positioning, or sensing.

5. The method of claim 3, wherein the resource or the resource set is configured for: sensing and/or communication, or measurement of sensing and/or communication.

6. The method of claim 3, wherein the parameter is related to at least one of time domain of the signal, frequency domain of the signal, coding domain of the signal, spatial domain of the signal, the resource, the resource set, or a sensing mode.

7. The method of claim 3, wherein the beam information or direction information is configured for sensing.

8. The method of claim 3, wherein the beam information, the direction information or the resource is configured per resource or per resource set.

9. The method of claim 6, wherein the sensing mode is related to at least one of: sensing by the first or second wireless communication device, sensing by at least one other wireless communication devices, or jointly sensed by the first or second wireless communication device and the at least one other device(s).

10. The method of claim 6, wherein the sensing mode is related to at least one of: the first or second wireless communication device conducting sensing, receiving or transmitting operations, the first or second wireless communication device conducting the transmitting operation and at least one other wireless communication device(s) conducting sensing or receiving operation, the first or second wireless communication device conducting the sensing or receiving operation and the at least one other wireless communication device(s) conducting transmitting operation, or the at least one other wireless communication device(s) conducting the sensing or receiving operation and the other wireless communication device(s) conducting transmitting operation.

11. The method of claim 6, wherein the parameter is 0 indicates the resource or the resource set is used for sensing, wherein the parameter is 1 indicates the resources or the resource set is used for communication or positioning.

12. The method of claim 6, wherein the parameter is 1 indicates the resource or the resource set is used for sensing, wherein the parameter is 0 indicates the resources or the resource set is used for communication or positioning.

13. The method of claim 3, wherein the configuration information comprising the parameter indicates sensing is supported.

14. The method of claim 3, wherein the configuration information comprising the parameter indicates sensing is not supported.

15. The method of claim 3, wherein the parameter is one or more enumeration value(s), at least one of: one or more enumeration value(s) indicating sensing, or one or more enumeration value(s) indicating positioning or communication.

16. The method of claim 1, wherein each use case maps to at least one configuration information.

17. The method of claim 16, wherein more than one use cases map to a same configuration information.

18. The method of claim 6, wherein the sensing mode is indicated by at least one of: one value indicates that the sensing, receiving, or transmitting operation are conducted at a same wireless communication device, or one value indicates that the sensing, receiving, transmitting operation are conducted at different wireless communication devices.

19-41. (canceled)

42. An apparatus for communication network, comprising: a processor configured to implement a method for wireless communication, wherein the method comprises:
communicating, by a first wireless communication device to a second wireless communication device, a signal including a configuration information; and
performing, by the second wireless communication device, an operation that combines a sensing functionality and a communication functionality using the configuration information for at least one use case(s).

43. A non-transitory computer-readable storage medium having code stored thereupon, the code, upon execution by a processor, causing the processor to implement a method for wireless communication, wherein the method comprises:
communicating, by a first wireless communication device to a second wireless communication device, a signal including a configuration information; and
performing, by the second wireless communication device, an operation that combines a sensing functionality and a communication functionality using the configuration information for at least one use case(s).
